(19) United States
(12) Patent Application Publication
(10) Pub. No.: US 2009/0125801 A1
(43) Pub. Date: May 14, 2009

(54) 3D windows system

(75) Inventor: Cherif Atia Algreatly, Newark, CA (US)

Correspondence Address: CHERIF ALGREATLY, 39962 CEDAR BLVD, SUITE 286, NEWARK, CA, 94560, US

(73) Assignee: CHERIF ATIA ALGREATLY, NEWARK, CA (US)

(21) Appl. No.: 12/290,730

(22) Filed: Nov. 3, 2008

Related U.S. Application Data
(60) Provisional application No. 61/002,592, filed on Nov. 10, 2007.

(51) Int. Cl. G06F 17/00; G06F 3/048

(52) U.S. Cl. 715/234; 715/763

(57) ABSTRACT

A 3D windows system that enables the user to create, edit, and/or interact with 3D graphics user interfaces on the computer display using an innovative technique that utilizes a plurality of matrices to model the 3D graphics user interfaces. Said 3D windows system serves various 3D desktop and Web-based applications without a need for specific hardware requirements or hardware accelerators. Furthermore, the file sizes of 3D applications that utilize said 3D windows system are extremely light and almost equal to the file sizes of traditional 2D applications.

### CROSS-REFERENCE TO RELATED APPLICATION

This application is a Continuation-in-Part of co-pending U.S. Patent Application No. 61/002,592, filed Nov. 10, 2007.

### BACKGROUND

In the last few years, new versions of Windows systems, Web-based applications, desktop software, and computer games have dramatically changed to integrate the use of three dimensional applications. Microsoft Windows Vista, Internet world mapping applications such as Google Earth, CAD software, and PlayStation 3 are examples of such applications.

The use of such three-dimensional applications requires a special computer input device, advanced hardware, and complex mathematical calculations. In addition to having some operating difficulties and visualization problems that excludes many users and software companies from supporting this 3D trend.

For example, to move or rotate objects in three dimensions on the computer display, the user needs a computer input device that provides six degrees-of-freedom such as a 3D mouse, where most of the computer users find the use of such a 3D mouse much more complicated than using the traditional 2D mouse.

The use of the three-dimensional applications demands specific hardware requirements or hardware accelerators to improve the manipulation performance of moving different objects of three-dimensional applications with the user input on the computer display. Such requirements add more constraints and prevent many users from using the three dimensional applications liberally.

In three-dimensional applications, there is always a project illusion problem that occurs on the computer display when the user manipulates the cursor to target a point/spot in 3D. That wastes the user time trying to reach his/her target on the computer display, accordingly, this problem makes the user frustrated with the performance of many three-dimensional applications in comparison to 2D applications which are much easer and simpler to interact with.

Additionally, file sizes of the three-dimensional applications are much bigger than file sizes of 2D applications which makes the majority of Web-based applications intentionally limit the use of numerous three-dimensional functions.

The aforementioned problems prevent having a distinct, universal 3D windows system that can be used for various desktop- and Web-based applications. Although Microsoft claims that their new version of Windows Vista is a 3D windows system, practically speaking, Microsoft Windows Vista has extremely limited three dimensional features and functionalities.

The present invention of the 3D windows system introduces a universal system that can be used for desktop applications without a need for specific hardware requirements or hardware accelerators. The traditional projection illusion problem becomes void when using the present 3D windows system, where the user can accurately target any point/object in 3D on the computer display in one step. Moreover, the user can move (or rotate) the targeted point/object in 3D on the computer display without a need for using a special computer input device or a 3D mouse.

Furthermore, the file sizes of three-dimensional applications that utilize the present invention are extremely light and almost equal to the size of traditional 2D applications. This advantage enables using the present invention with different Web-based applications, where it is very simple to download and upload the files of the present invention.

### SUMMARY

The present 3D windows system enables the user to create his/her own 3D graphical user interface (GUI), where the shape of said created 3D GUI can be changed from one application to another or from time to other according to the user needs or preferences.

The present invention gives the user different alternatives of initial GUI's where the user can choose one from them, and start forming/designing his/her own 3D GUI.

In said initial GUI the user can create different planes and move, divide, delete, copy, paste, rotate, or change the transparency of these planes to form/design his/her preferable 3D GUI.

In present 3D GUIS, the different shortcuts, icons, menus, images, or display windows can take different 3D shapes according to the user's choice. The user can change the size or dimensions of these 3D shapes to suit the design of his/her 3D GUI.

The present 3D GUI can be used for many applications, for example, it can be used as a 3D desktop to organize numerous shortcuts of different files on the computer display. It can also be used for websites to display the images, text, and menus of the websites pages in three dimensions. Another application is to use the 3D GUI for various software applications such as Microsoft Office to present the toolbars and display windows in three dimensions on the computer display.

The present 3D windows system introduces a new 3D visualization technique that enables the user to interact with the 3D GUI on the computer display in an innovative manner. The user can create, change, or move any part of said 3D GUI in three dimensions on the computer display without having the operating difficulties of the traditional three dimensional applications as will be described subsequently.

### BRIEF DESCRIPTION OF THE DRAWINGS

FIGS. 1 to 4 are four examples for different perspectives of a space that can be used as an initial GUI on the computer display.

FIG. 5 is an example for an initial GUI in a shape of interior space presented on a computer display.

FIG. 6 is a small circle that appears on a line in the initial GUI when the cursor is moved to the position of this small circle.

FIG. 7 is a corner icon that appears on the position of the small circle when the user clicks on the small circle.

FIGS. 8 to 10 are xy, xz, or yz-corner planes that appear when the cursor is moved between any two lines of the corner icon.

FIG. 11 is a horizontal plane created when the user clicks on the xy-corner plane of the corner icon.

FIG. 12 is a small circle that appears on a line of the created horizontal plane when the cursor is moved to the position of this small circle on the line.

FIG. 13 is a corner icon that appears on the position of the small circle when the user clicks on the small circle.

FIG. 14 is a yz-corner plane that appears when the cursor is moved between the y-corner line and the z-corner line of the corner plane.

FIG. 15 is a vertical plane created when the user clicks on the yz-corner plane of the corner icon.

FIG. 16 is a small circle that appears on a corner of the vertical plane when the cursor is moved to the positions of this corner.

FIG. 17 is a corner icon that appears on the position of the small circle when the user clicks on the small circle.

FIG. 18 is moving the vertical plane parallel to the x-axis when the small circle is dragged parallel to the x-axis on the computer display.

FIGS. 19 to 21 are three steps to move the horizontal plane parallel to the z-axis on the computer display.

FIGS. 22 and 23 are two steps to move a polygon independently from its horizontal plane on the computer display.

FIGS. 24 and 25 are two steps to delete a polygon independently from its vertical plane on the computer display.

FIGS. 26 and 27 are two steps to move a polygon independently from its vertical plane on the computer display.

FIGS. 28 and 29 are two steps to copy and paste two polygons of the 3D GUI on the computer display.

FIGS. 30 and 31 are two steps to copy and paste a plane of the 3D GUI on the computer display.

FIGS. 32 and 33 are two steps to rotate a plane from a horizontal position to a vertical position on the computer display.

FIG. 34 is an example for a 3D GUI comprised of a plurality of planes created in an initial GUI on the computer display.

FIG. 35 is the 3D GUI of FIG. 34 after changing the transparency of its planes into opaque planes.

FIG. 36.1 is a cube that represents an icon, menu, shortcut, or display window in a 3D GUI on a computer display.

FIG. 36.2 is a small circle that appears on a corner of the cube when the cursor is moved to the position of this corner on the computer display.

FIG. 36.3 is a corner icon that appears on the position of the small circle when the user clicks on the small circle.

FIGS. 37.1 to 37.3 are three examples for changing the shape of the cube on the computer display.

FIGS. 38.1 to 38.4 are moving a cube on a horizontal plane parallel to the x, y, and z-axis on the computer display.

FIGS. 39.1 to 39.3 are positioning three cubes on top of each other on the computer display.

FIGS. 40.1 to 40.3 are three examples for a shape of a drop-down menu in a 3D GUI presented on the computer display.

FIG. 41 is an example for a 3D GUI that looks like a bookshelf containing various shortcuts on a desktop of a computer display.

FIGS. 42.1 and 42.2 are an example for a 3D GUI presenting a Microsoft Word file in three dimensions on the computer display.

FIGS. 43.1 and 43.2 are an example for a 3D GUI presenting a website in three dimensions on a computer display.

FIG. 44 is an initial GUI of a one-point perspective with one vanishing point presented on a computer display.

FIG. 45 is the created planes on the computer display that are parallel to the xy-plane of the initial GUI that are possible.

FIG. 46 is the created planes on the computer display that are parallel to the yz-plane of the initial GUI that are possible.

FIG. 47 is the created planes on the computer display that are parallel to the xz-plane of the initial GUI that are possible.

FIG. 48 is 10 matrices that represent the 10 possible created planes that are parallel to the xy-plane of the initial GUI.

FIG. 49 is 14 matrices that represent the 14 possible created planes that are parallel to the yz-plane of the initial GUI.

FIG. 50 is 6 matrices that represent the 6 possible created planes that are parallel to the xz-plane of the initial GUI.

FIG. 51 is one of the possible created planes that is parallel to the xy-plane of the initial GUI.

FIG. 52 is the correspondent matrix of the xy-plane of FIG. 51 where the “1” numeral indicates an existence of a node.

FIG. 53 is the xy-plane extracted form the matrix of FIG. 52 and presented on the computer display.

FIG. 54 is one of the possible created planes that is parallel to the yz-plane of the initial GUI.

FIG. 55 is the correspondent matrix of the yz-plane of FIG. 54 where the “1” numeral indicates an existence of a node.

FIG. 56 is the yz-plane extracted from the matrix of FIG. 55 and presented on the computer display.

FIG. 57 is the xy-plane and the yz-plane presented simultaneously on the computer display.

FIG. 58 is the xy-plane and the yz-plane presented simultaneously on the computer display without the lines of the trapezoids.

FIG. 59 is four possible intersections for two planes in a 3D GUI presented on a computer display.

FIGS. 60.1 to 60.4 are moving the point-of-view on the x, and y-axis on the computer display.

FIG. 61.1 to 61.4 are the steps of positioning a node on the computer display using the x, y, and z coordinates of the perspective grid.

FIG. 62 is a two-point perspective with two vanishing points that determine the direction of the x, y, and z coordinates of the perspective grid when positioning a node on the computer display.

FIG. 63 is a three-point perspective with three vanishing points that determine the direction of the x, y, and z coordinates of the perspective grid when positioning a node on the computer display.

### DETAILED DESCRIPTION

Perspective is the way in which objects appear to the eye based on their spatial attributes, or their dimensions and the position of the point-of-view relative to the objects. There are three types of perspective: one-point perspective, two-point perspective, and three-point perspective.

The one-point perspective has one vanishing point, the two-point perspective has two vanishing points, and the three-point perspective has three vanishing points. The vanishing point, as known in the art, is a point in the perspective to which parallel lines appear to converge.

The present 3D windows system presents a plurality of initial GUI's where the user can choose one of them, and start forming or designing his/her own 3D GUI. The initial GUI's can be various types of perspectives where each perspective has a unique shape and/or different positions for the vanishing points.

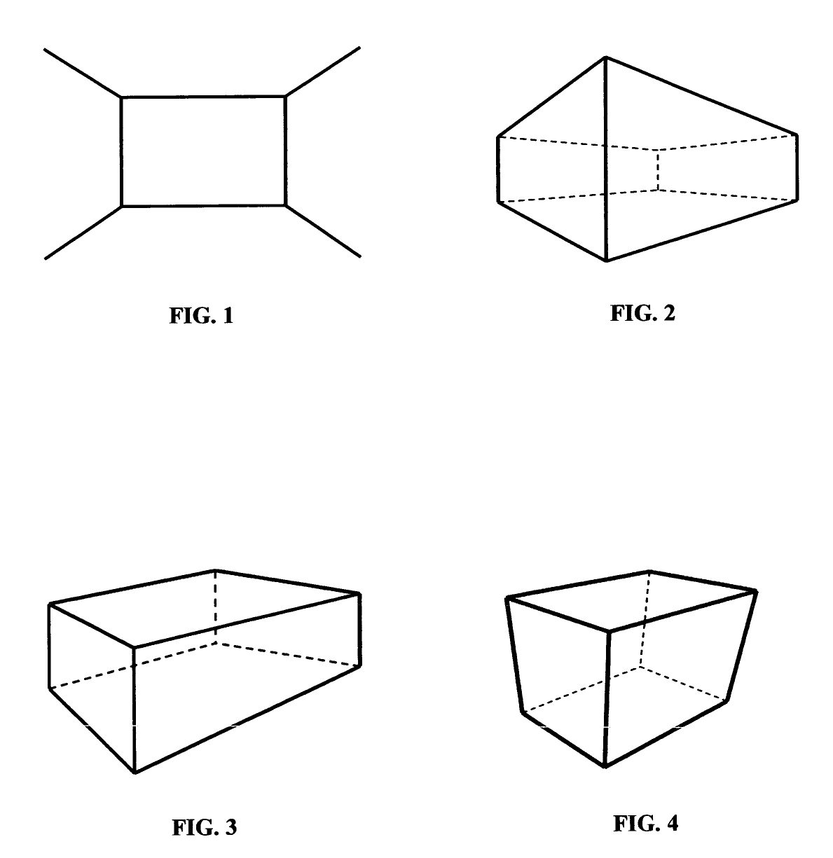

FIGS. 1 to 4 illustrate four different alternatives of initial GUI's that are presented on a computer display. FIG. 1 illustrates a one-point perspective for a space where the point-of-view is located inside the space. FIG. 2 illustrates a two-point perspective for a space where the point-of-view is located outside this space between the base and the top side of the space. FIG. 3 illustrates another two-point perspective for a space where the point-of-view is located above the top side of the space. FIG. 4 illustrates a three-point perspective for a space where the point-of-view is also located above the top side of the space.

The user can start using any of the previous initial GUI's to form or design his/her preferred 3D GUI. Whereas the present 3D windows system enables the user to create new planes, and to move, divide, delete, copy, paste, or rotate said new planes in the initial GUI's on the computer display.

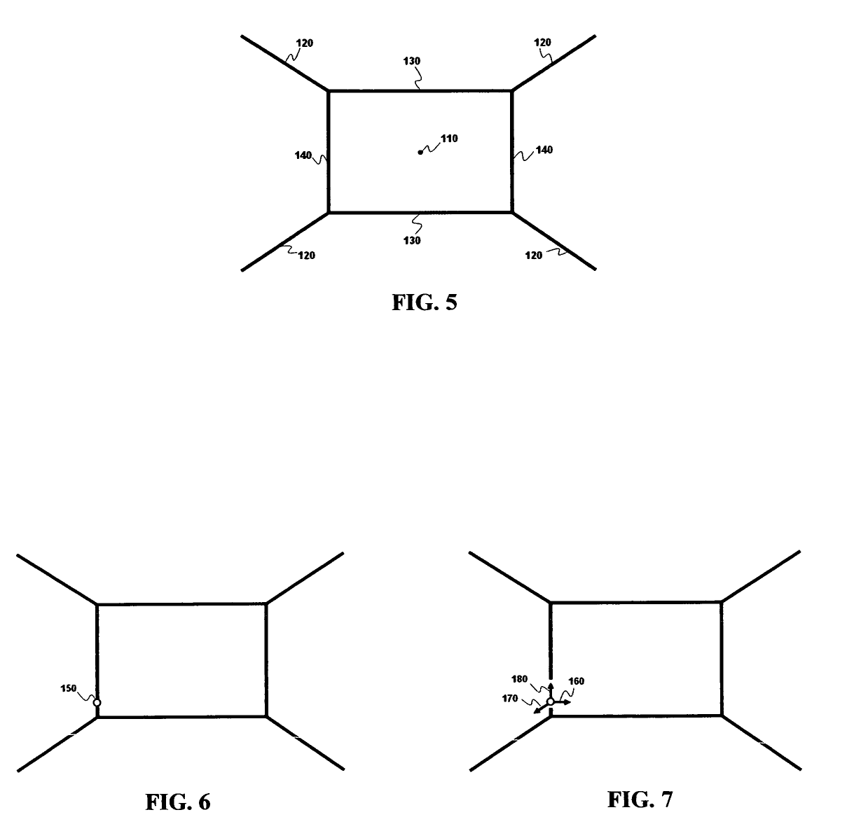

For example, FIG. 5 illustrates an initial GUI presented on a computer display where this initial GUI is a one-point perspective of an interior space. As shown in the figure, the initial GUI is comprised of a vanishing point 110, four sloped lines 120, two horizontal lines 130, and two vertical lines 140.

The horizontal lines are parallel to the direction of the x-axis of the space, the sloped lines are parallel to the direction of the y-axis of the space, and the vertical lines are parallel to the direction of the z-axis of the space. In such one-point perspective the extension of all lines that are parallel to the direction of the y-axis of the space must meet at the vanishing point.

The user can change the shape of this initial GUI into other shapes by creating different planes. For example, when the user moves the cursor to any line of the initial GUI lines a small circle appears where the cursor intersects with the line. FIG. 6 illustrates a small circle 150 that appears on a position of a point on one of the vertical lines of the initial GUI when the cursor is moved to the position of this point.

FIG. 7 illustrates a corner icon that appears on the position of the small circle when the user clicks on the small circle. The corner icon is comprised of an x-corner line 160 representing the x-axis, a y-corner line 170 representing the y-axis, and a z-corner line 180 representing the z-axis of the space. The x-corner line, the y-corner line, and the z-corner line meet at the position of the small circle as illustrated in the figure.

Depending on the number of the vanishing points of the perspective and the position of the small circle, one or more of the extensions of x, y, or z-corner lines intersects with the vanishing point/s. For example, in FIG. 7 the extension of the y-corner line 170 intersects with the vanishing point.

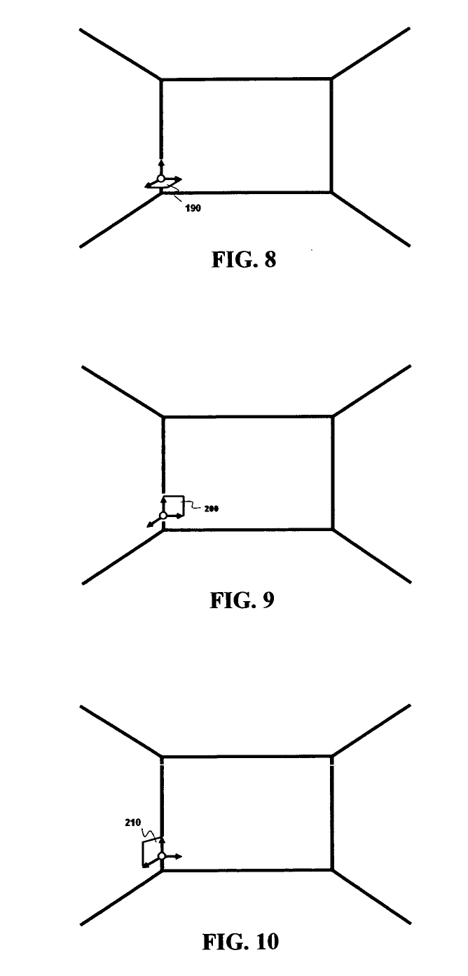

FIG. 8 illustrates a xy-corner plane 190 that appears between the x-corner line and the y-corner line when the cursor is moved between them, where this xy-corner plane represents the xy-plane of the space. FIG. 9 illustrates an xz-corner plane 200 that appears between the x-corner line and the z-corner line when the cursor is moved between them, where this xz-corner plane represents the xz-plane of the space. FIG. 10 illustrates a yz-corner plane 210 that appears between the y-corner line and the z-corner line when the cursor is moved between them, where this yz-corner plane represents the yz-plane of the space.

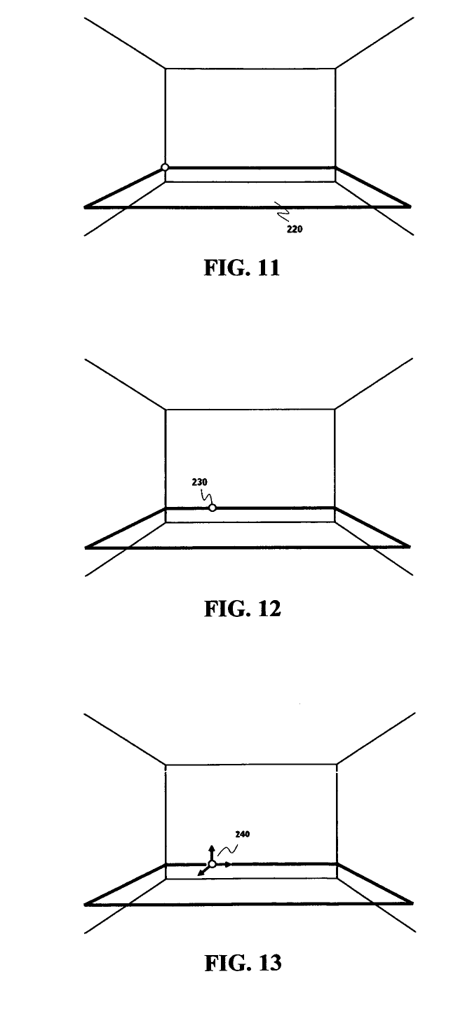

FIG. 11 illustrates an xy-plane 220 that appears in the interior space on the computer display when the user clicks on the xy-corner plane 190. Said xy-plane starts from the position of the small circle 150 and intersects with the xz-planes and the yz-planes of the space as shown in the figure.

Generally, when the user clicks on the xz-corner plane, an xz-plane appears in the interior space on the computer display. Also, when the user clicks on the yz-corner plane, a yz-plane appears in the interior space on the computer display. However, in this step of this example the user chose to click on the xy-plane to create the xy-plane of FIG. 11.

FIG. 12 illustrates a small circle 230 that appears on a line of the created xy-plane of FIG. 11 when the user moves the cursor to the position of this small circle on this line. When the user clicks on the small circle, a corner icon 240 appears on the position of the small circle as illustrated in FIG. 13, whereas this corner icon is similar to the corner icon of FIG. 7.

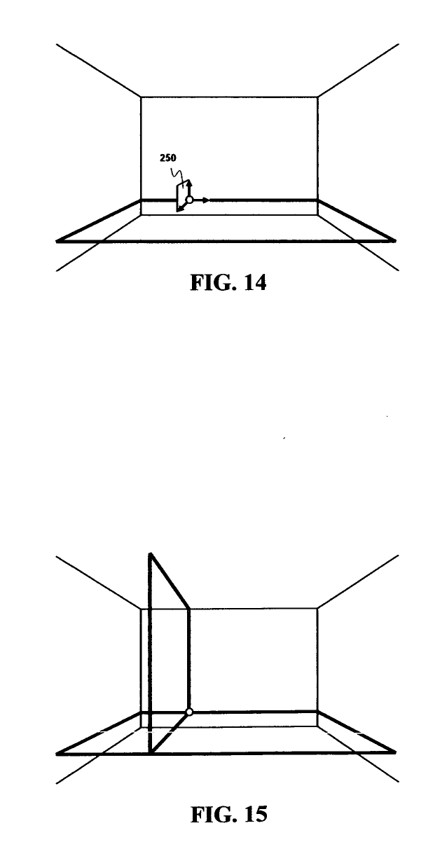

FIG. 14 illustrates a yz-corner plane 250 that appears when the user moves the cursor between the y-corner line and the z-corner line of the corner icon as described previously. FIG. 15 illustrates a yz-plane that appears in the interior space on the computer display when the user clicks on the yz-corner plane 250. Said yz-plane starts from the position of the small circle 230 and intersects with the closest xy and xz-plane of the interior space as shown in the figure.

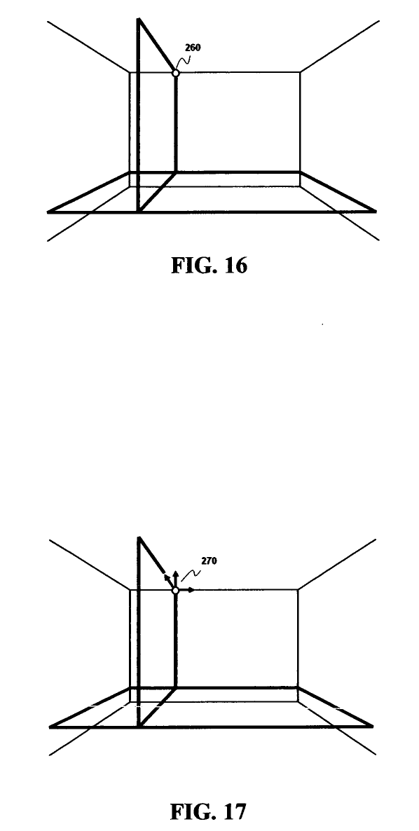

The user can move any of the created planes in the initial GUI on the computer display. For example, FIG. 16 illustrates a small circle 260 that appears on a corner of the created yz-plane when the cursor is moved to the position of this corner. FIG. 17 illustrates a corner icon 270 that appears on the position of the small circle when the user clicks on this small circle.

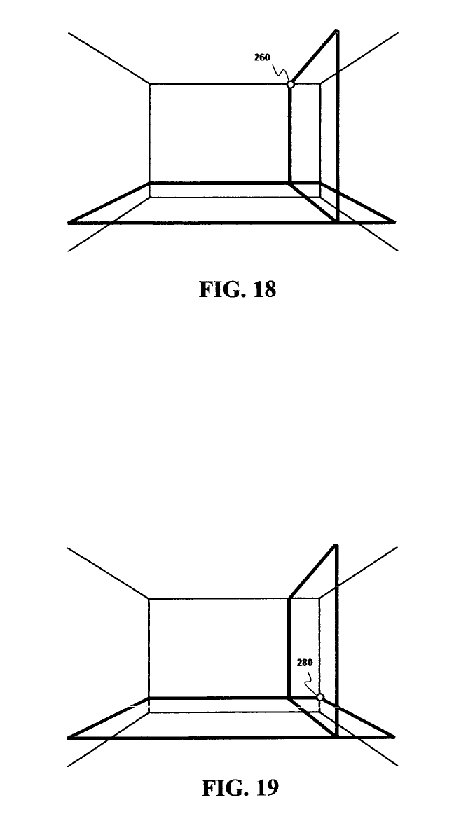

FIG. 18 illustrates moving the yz-plane when the small circle is dragged on the computer display from “left” to “right” parallel to the x-axis of the space. If the small circle is dragged parallel to the y-axis the yz-plane will be moved parallel to the y-axis of the space. Also, if the small circle is dragged parallel to the z-axis, the yz-plane will be moved parallel to the z-axis of the space.

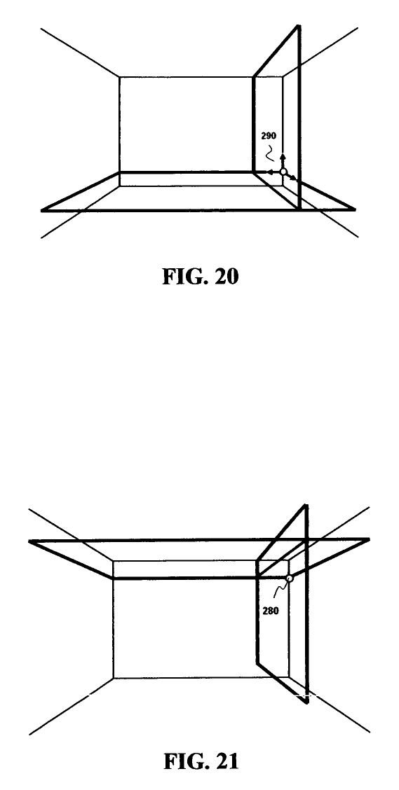

FIG. 19 illustrates a small circle 280 that appears on a corner of the created xy-plane when the cursor is moved to the position of this corner. FIG. 20 illustrates a corner icon 290 that appears on the position of the small circle when the user clicks on this small circle.

FIG. 21 illustrates moving the xy-plane from “down” to “up” in the interior space when the small circle is dragged from “down” to “up” parallel to the z-axis of the space on the computer display.

Whereas the previous examples described moving the created planes in the initial GUI, the following examples describe editing the created planes, where this editing includes all options that enable the user to change the shape of the created planes. For example, the user can divide, delete, copy, paste, rotate, and change transparency of the created planes.

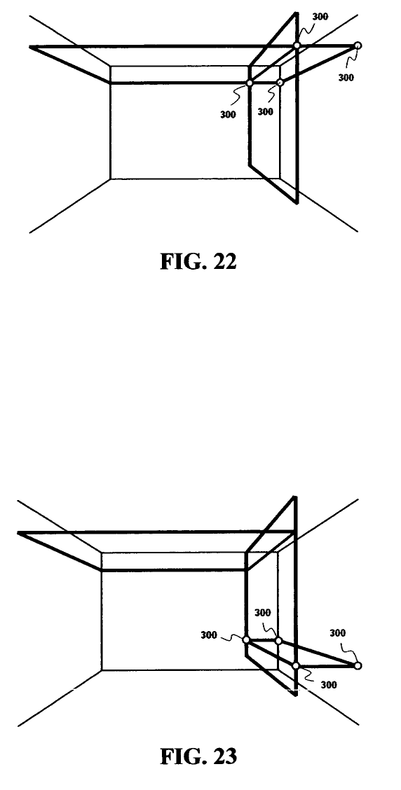

FIG. 22 illustrates four small circles 300 that appear on four corners of the created horizontal plane where the user clicks with the right button of the mouse when the cursor is successively positioned on each one of the four corners.

Specifying a plurality of small circles as previously described indicates that the polygon that connects between the small circles is separated from its created or original plane and can be moved independently from this original plane.

For example, when the user drags any one of the four small circles on the computer display, after specifying them, the polygon that connects between these four small circles will be dragged independently from its horizontal plane parallel to the direction of the cursor movement in 3D on the computer display.

FIG. 23 illustrates moving said polygon from “up” to “down” parallel to the z-axis of the space when the cursor drags one of the four small circles from “up” to “down” parallel to the z-axis of the space on the computer display.

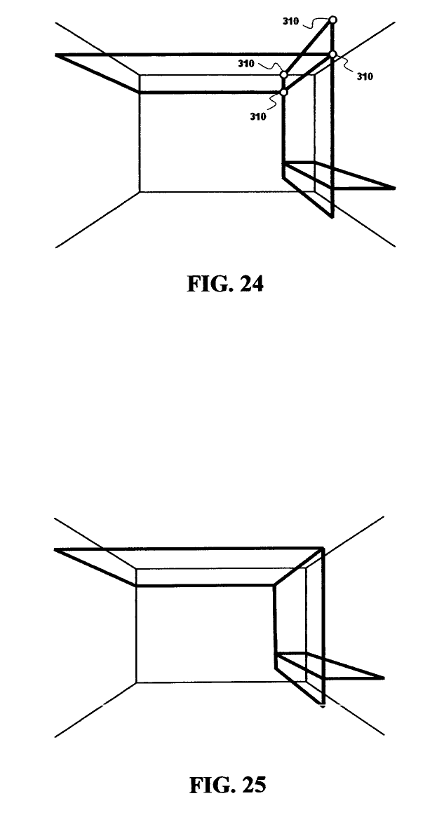

FIG. 24 illustrates specifying another four small circles 310 on four corners of the vertical plane in the interior space. In this case the user chose to delete the polygon that connects between the four small circles as illustrated in FIG. 25.

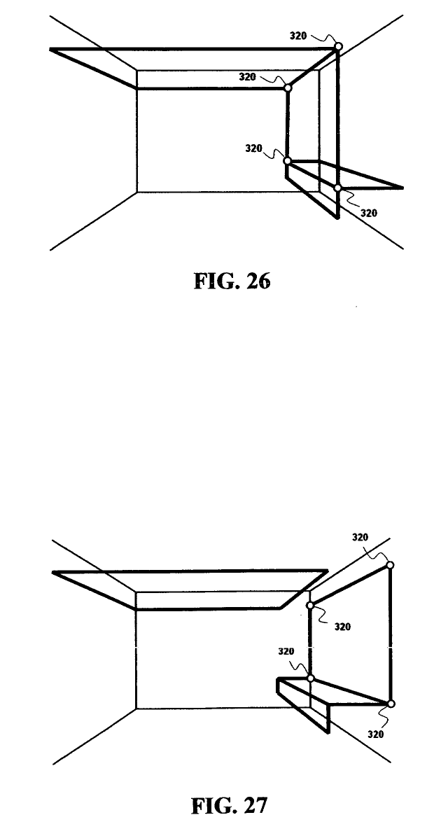

FIG. 26 illustrates specifying another four small circles 320, and FIG. 27 illustrates moving the polygon that connects between these four small circles from “left” to “right” parallel to the x-axis of the space when one of the four small circles is dragged from “left” to “right” parallel to the x-axis of the space on the computer display.

It is possible to enable the user to edit the polygon which connects between a plurality of small circles by using a drop-down menu that appears on the computer display when the user clicks on the right button of the computer mouse after specifying the plurality of the small circles. Said drop-down menu includes the alternatives or options of editing polygons such as move, delete, copy, paste, rotate, and change transparency of the polygon.

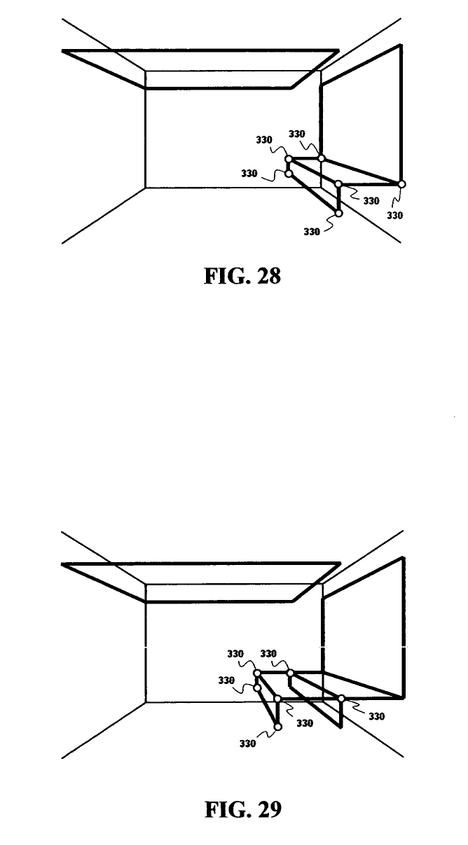

FIG. 28 illustrates specifying six small circles 330 that form two polygons on two different planes, where the user copied and pasted these two polygons in other positions in the interior space on the computer display as illustrated in FIG. 29. In this case the user chose the “copy” and “paste” options of the suggested drop down menu.

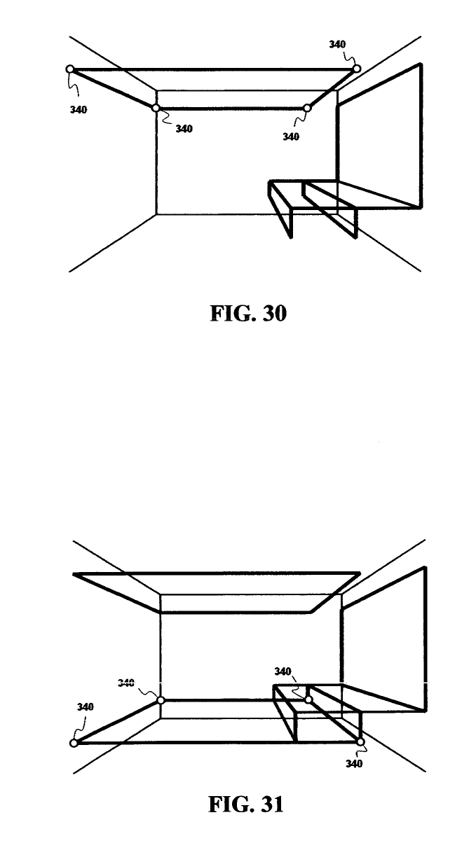

FIG. 30 illustrates specifying another four small circles 340 of a polygon on one of the created horizontal planes, while FIG. 31 illustrates copying and pasting this polygon in another position in the interior space on the computer display.

Generally, to copy and paste a polygon in a specific position in the present 3D GUI on the computer display, the user drags one of the small circles of the polygon to the specific position where the entire polygon is then dragged relative to the position of this small circle in the present 3D GUI on the computer display.

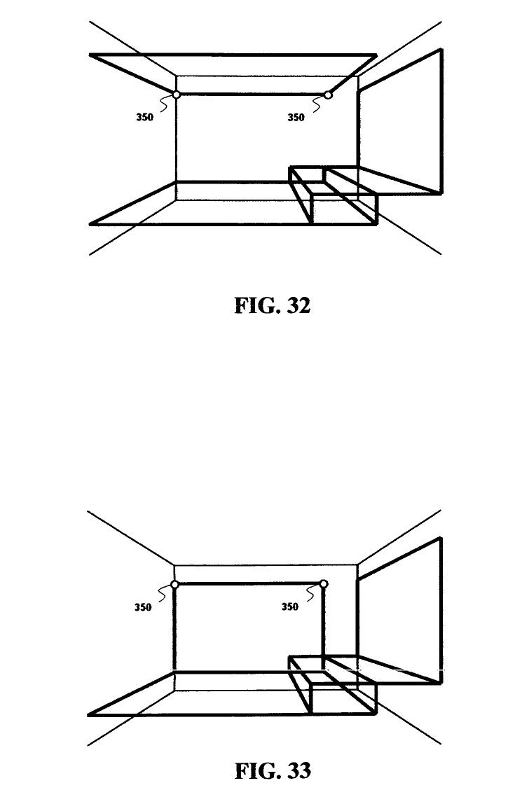

FIG. 32 illustrates specifying two small circles 350 on one of the created horizontal planes where the user chose to rotate this plane as illustrated in FIG. 33. The rotation in these cases can be a clockwise or a counter-clockwise rotation with a rotational value of 90, 180, or 270 degrees. The user can choose the rotation option and the rotational value from the suggested drop-down menu.

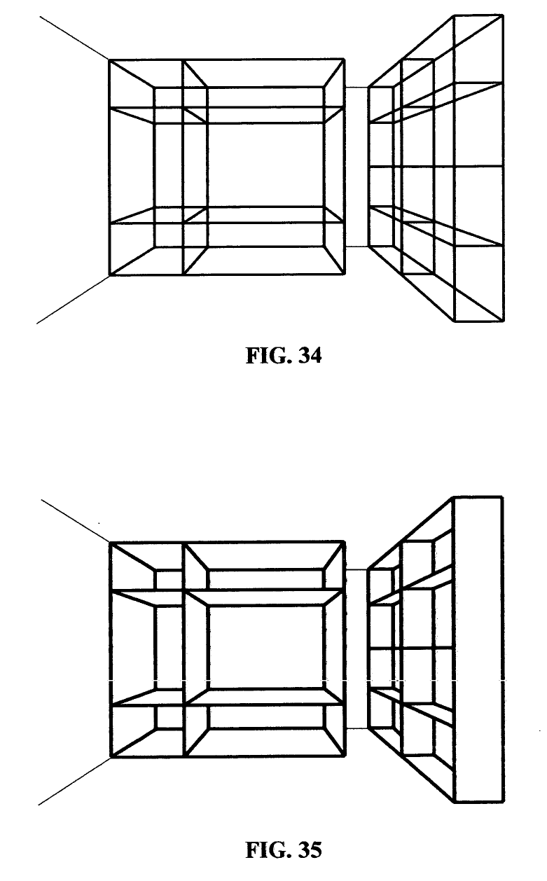

Using the previously described options of the present 3D GUI to create, move, divide, delete, copy, paste, or rotate planes, the user is able to create his/her preferred shapes of 3D GUI's. FIG. 34 illustrates an example for a 3D GUI presented on a computer display where this 3D GUI was created using the previously described options to looks like two bookshelfs that contain and display a plurality of shortcuts, icons, menus, or toolbars on the computer display as will be described subsequently.

FIG. 35 illustrates the same 3D GUI of FIG. 34 after changing the transparency of its created planes from transparent planes into opaque planes. Converting the transparent planes into opaque planes makes the 3D GUI appear clearer to the user on the computer display. As mentioned previously, to change the transparency of the created planes, the user will choose the option of “change transparency” from the suggested drop down menu.

The previous examples described creating, moving, and editing different planes in the initial GUI. The following examples illustrate forming 3D shapes for different icons, menus, images, or display windows of software programs in the present 3D GUI on the computer display.

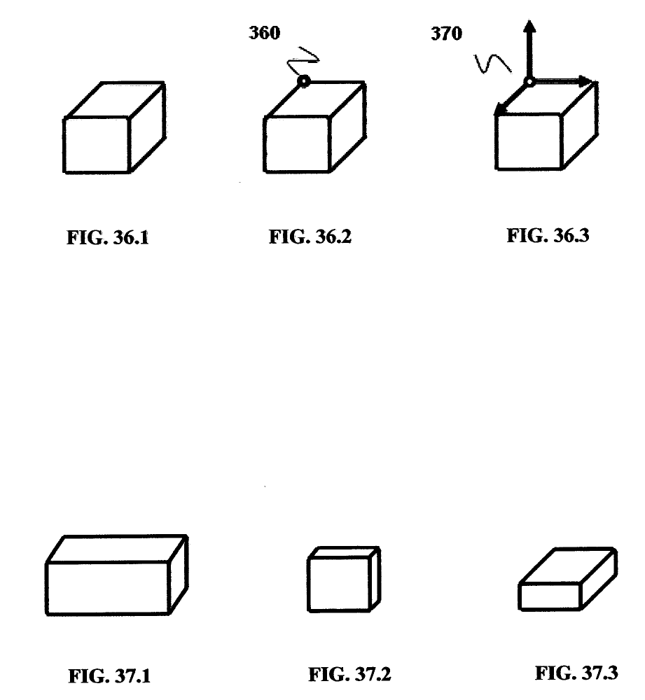

FIG. 36.1 illustrates a cube representing a shortcut, icon, menu, image, or display window in the present 3D GUI on the computer display. FIG. 36.2 illustrates a small circle 360 that appears on one of the cube corners when the cursor is moved to the position of this corner. FIG. 36.3 illustrates a corner icon 370 that appears on the position of the small circle when the user clicks on the small circle.

To reshape this cube, the user drags the small circle 360 in the direction or the opposite direction of the x, y, or z-corner line of the icon corner. For example, FIG. 37.1 illustrates resizing the cube when the small circle is dragged parallel to the direction of the x-corner line. FIG. 37.2 illustrates resizing the cube when the small circle is dragged parallel to the direction of the y-corner line. FIG. 37.3 illustrates resizing the cube when the small circle is dragged parallel to the opposite direction of the z-corner line.

To enable the user to move this cube in the present 3D GUI on the computer display, the user will drag the small circle 360 in the direction of (or opposite) the x, y, or z-corner line of the icon corner. To enable the computer system to distinguish the difference between the user input to drag the small circle for resizing or moving the cube, the user utilizes the left button of the mouse while dragging the small circle to resize the cube, and utilizes the right button of the mouse while dragging the small circle to move the cube on the computer display.

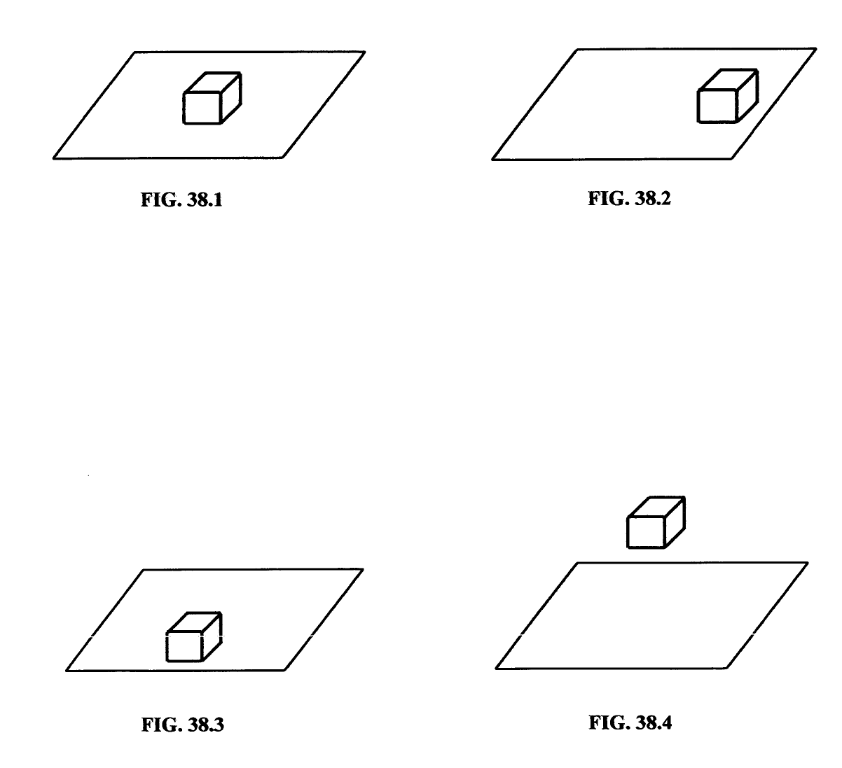

FIG. 38.1 illustrates said cube placed on a horizontal plane in a 3D GUI on the computer display, where FIG. 38.2 illustrates moving the cube parallel to the x-axis, FIG. 38.3 illustrates moving the cube parallel to the y-axis, and FIG. 38.4 illustrates moving the cube parallel to the z-axis on the computer display.

In such cases, to move the cube form a start position to an end position in the present 3D GUI on the computer display, the cube needs a plane to support it. For example in FIG. 38.4 the cube cannot stay in this illustrated position away from a supporting plane, in other words, the cube will fall down to its original position after the user stops dragging it to this position where there is no plane to support or carry the cube.

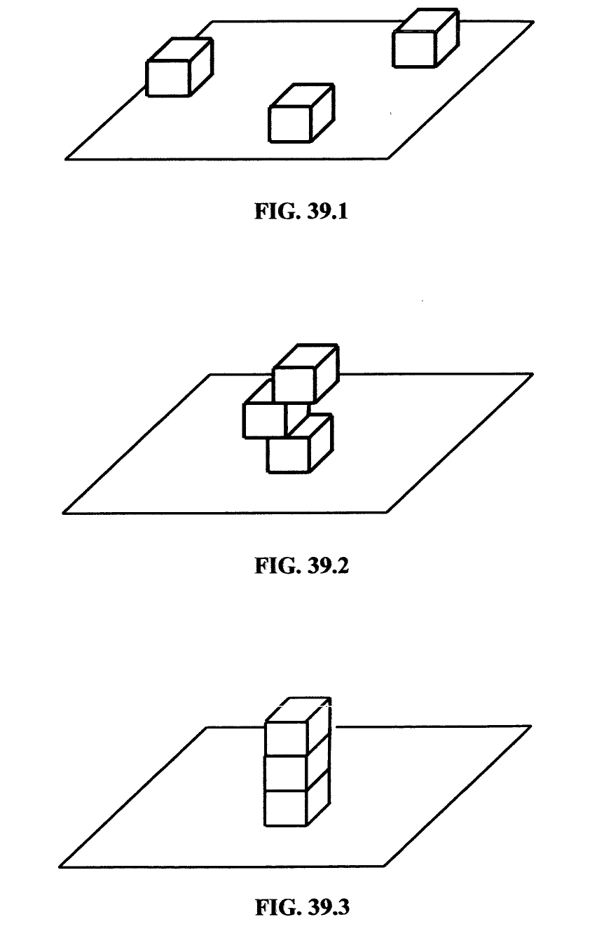

FIG. 39.1 illustrates three cubes placed on a horizontal plane in a 3D GUI on the computer display, where the user can move and place these cubes on top of each other as illustrated in FIGS. 39.2 and 39.3. In such cases, some cubes carry or support other cubes instead of using a supporting plane as previously described.

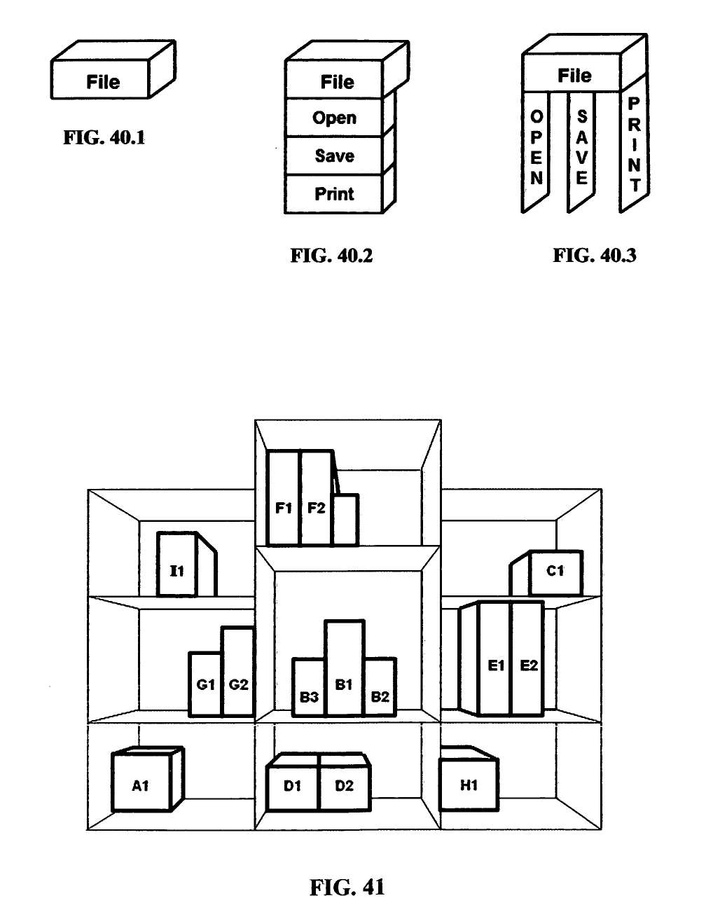

FIG. 40.1 illustrates an example for a 3D block representing a “File” menu in the present 3D GUI on the computer display, where this “File” menu includes the common “Open”, “Save”, and “Print” options. FIG. 40.2 illustrates the shape of the “File” menu options that appear on the computer display when the user clicks on the 3D block, whereas in this figure the menu options are also configured in a shape of 3D blocks. FIG. 40.3 illustrates another alternative for the menu options that are configured in a shape of rectangular surfaces.

FIG. 41 illustrates an example for a 3D GUI designed to look like a bookshelf that organizes and displays different files on the computer display. The files are symbolized in Latin letters such as A, B, C, D, E, F, G, H, and I, where each Latin letter represents a file type. There is a numeral beside each Latin letter to represent the names of the different files of the same type.

Such 3D GUI can be used for different purposes, for example, it can be used as a 3D desktop to display the different shortcuts that are usually presented on the traditional desktop. It can also be used for the common “Open” option of the “File” menu that is usually included in software programs such Microsoft Office. Using such 3D GUIs enables the user to easily locate the needed shortcut or file among a plurality of many shortcuts or files in a minimal amount of time.

As described previously, the user can move these files in 3D on the computer display to re-arrange them, and can change the dimensions of these files in 3D to resize them. The user can also modify the design of such a bookshelf of this 3D GUI from time to time, or from one application to another according to his/her needs or preferences.

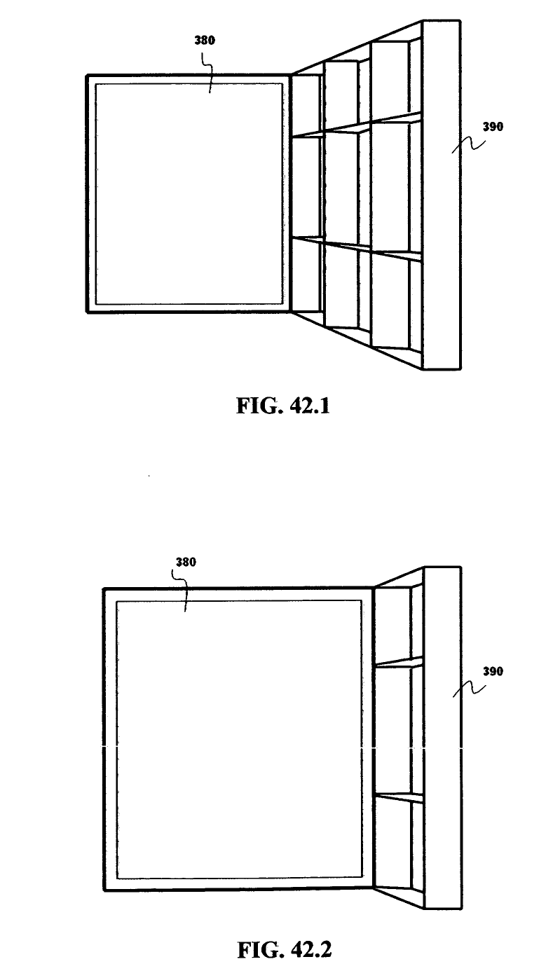

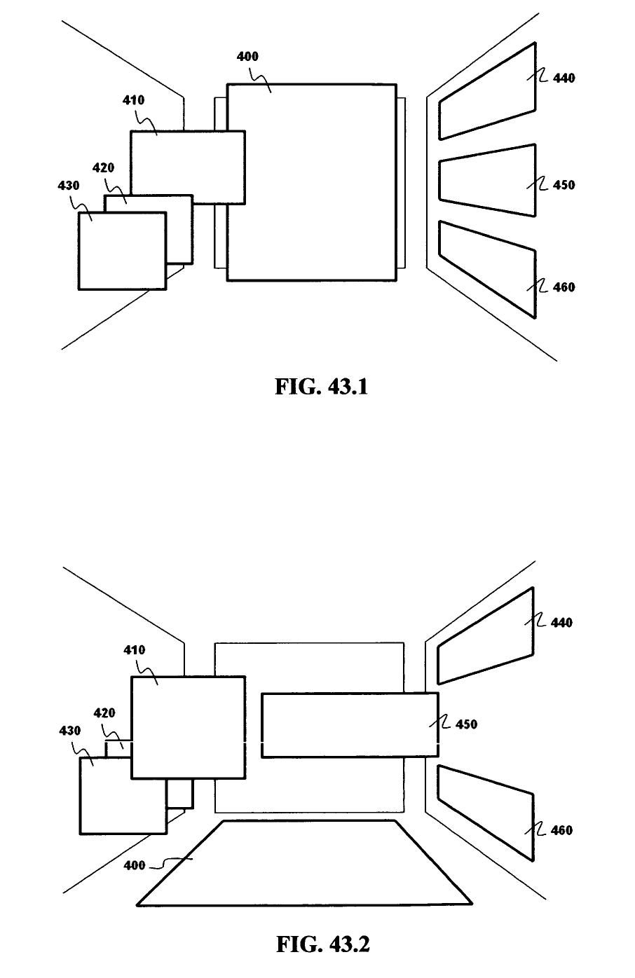

FIG. 42.1 illustrates another example for a 3D GUI presented on the computer display comprised of a 3D display window 380 presenting a program page such as a Microsoft Word document, a Microsoft PowerPoint slide, or the like, and a virtual bookshelf 390 that contains the different toolbars, icons or menus of this program page.

In such a case, the user can move the display window 380 forward or backward to zoom in/out of the program page. FIG. 42.2 illustrates moving the display window 380 forward to zoom into the program page while FIG. 42.1 illustrates moving the display windows 380 backward to zoom out of the program page.

It is also possible for the user to divide the virtual bookshelf 390 into two or more parts, and move these parts to the right, left, top, or bottom of the display window 380 to change the shape of the 3D GUI on the computer display.

FIG. 43.1 illustrates an example for another 3D GUI of a Web-based application of a website where the text, images, and menus of said website pages are displayed on seven three dimensional surfaces 400 to 460 in the 3D GUI on the computer display.

The user or visitor of this website can move any one of the seven surfaces in 3D on the computer display to re-arrange them. For example, in FIG. 43.2 the user rotated surface 400 to change its vertical position to a horizontal position, also the user moved surface 410 forward to be in front of surfaces 420 and 430, and rotated surface 450 to be near the middle of the computer display instead of being on its side.

The possibility of having such 3D GUIs enriches the interactivity performance of various websites, and gives the user more excitement while browsing or visiting the different pages of such websites, where the user can re-arrange the text and images of the website in 3D on the computer display the way s/he prefers.

As mentioned previously the present invention of the 3D windows system is a universal system that is not only used for desktop applications but for Web-based applications as well. Due to the minimal file size(s) attained through the use of the present invention, the upload and download of the Web-based applications that use this system are dramatically faster than other three-dimensional applications. Additionally, there is no need for specific computer hardware requirements when using the present invention as traditional three-dimensional applications require.

The user of the present 3D windows system has full control to manipulate the different objects of the present 3D GUI to move in 3D on the computer display without a need for a special computer input device. The projection illusion problem that is common when using traditional three-dimensional applications on the computer display becomes void when using the present invention.

Generally, the present invention of the 3D windows system is comprised of two main parts: a perspective grid and planar matrices.

The perspective grid is a 2D depiction for a 3D object from a specific point-of-view, whereas the 3D object is comprised of a number of planes that are divided into a plurality of hidden polygons. The lines of the perspective grid that are parallel to the x, y, or z-axis of the 3D object meet at one or more vanishing point/s. Connecting some corners of the hidden polygons on the computer display enables the user to create a plurality of planes that form a 3D GUI.

The perspective grid serves two functions: enabling the user to graphically express his/her input to the computer system when s/he needs to create, move, or edit a plane on the computer display, and graphically displaying the output of the planar matrices on the computer system.

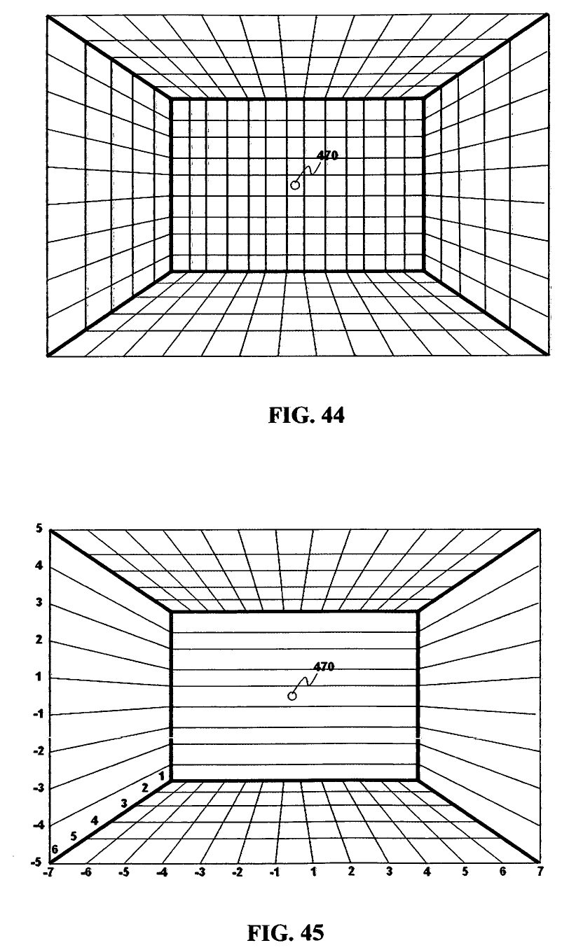

FIG. 44 illustrates an example for a perspective grid representing an interior space comprised of five sides where the vanishing point 470 of this interior space is located in the center of the computer display. In this example there are 10 xy-planes, 14 yz-planes, and 6 xz-planes represented by a number of intersected lines as shown in the figure.

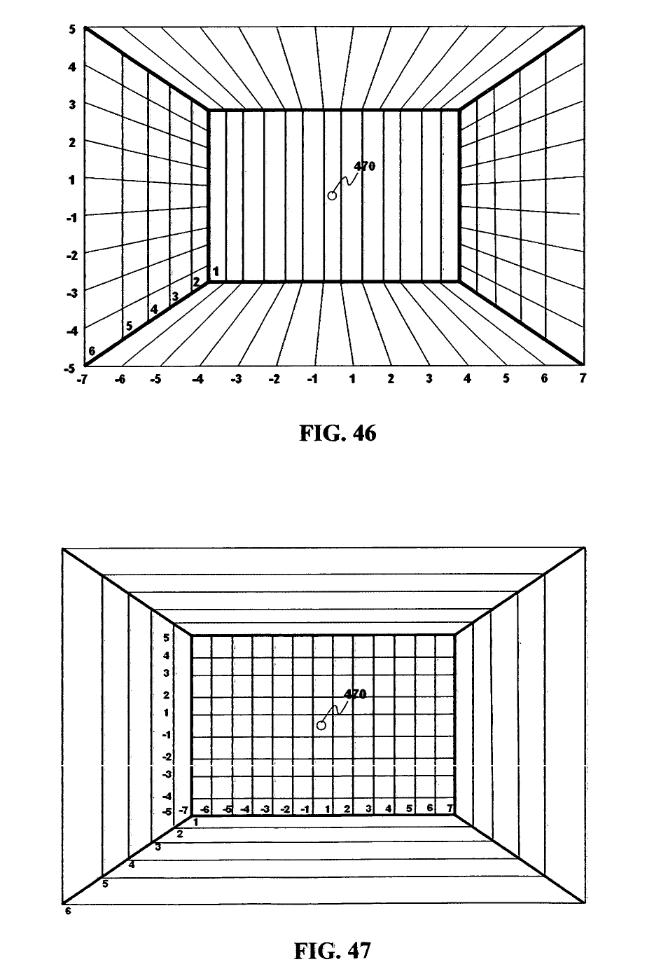

The intersections of the xy, yz, and xz-planes of this interior space divide each plane into a plurality of rectangles or trapezoids. FIG. 45 illustrates the trapezoids of the xy-planes, FIG. 46 illustrates the trapezoids of the yz-planes, and FIG. 47 illustrates the rectangles of the xz-planes. As shown in these three figures, the planes that are located on the left or below the vanishing point are assigned with negative ID's while the planes that are located on the right or above the vanishing point are assigned with positive ID's.

Each rectangle or trapezoid has four corners or nodes, where each node is a result of an intersection between two or three planes; accordingly, the same node can be located in one, two, or three planes. Each node can be defined with three components (x, y, and z) of the perspective grid relative to the vanishing point, and also can be defined with the x′, and y′ components of the computer display as will be described subsequently.

The second part of the present invention is the planar matrices which are comprised of a plurality of matrices where each matrix represents one of a potential xy, yz, or xz-planes of the perspective grid. Each cell in each matrix represents one node/corner of a rectangle or a trapezoid.

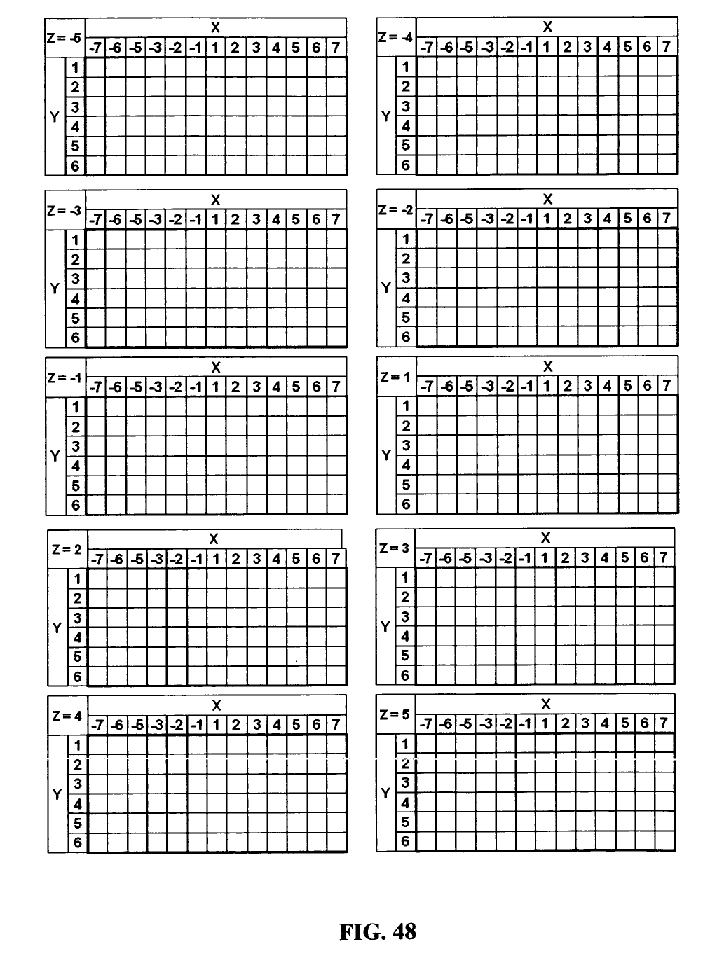

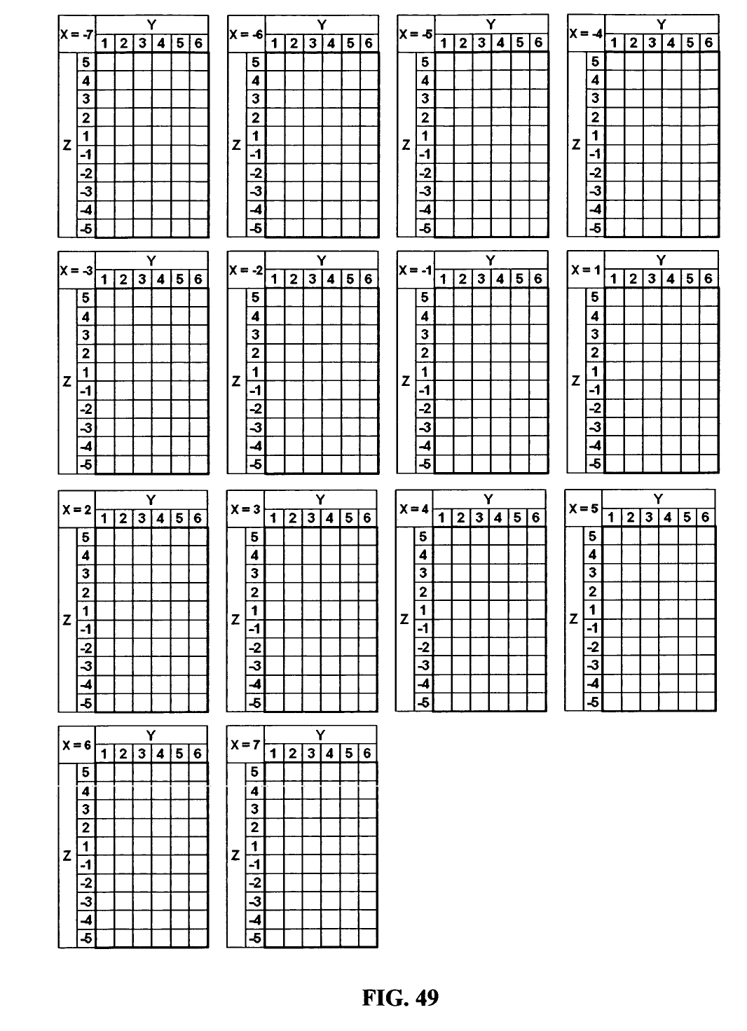

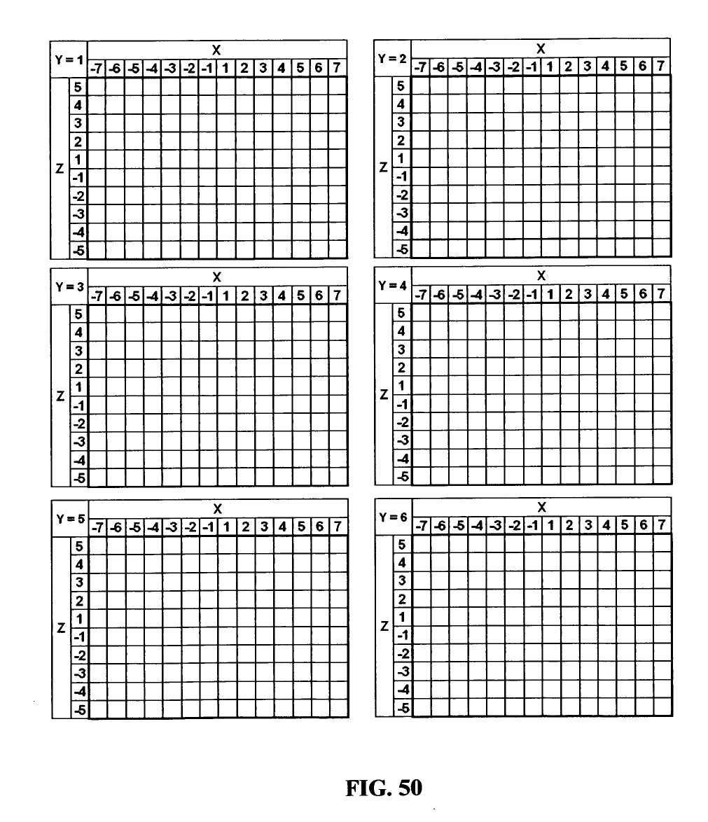

For example, FIG. 48 illustrates 10 matrices representing the 10 potential xy-planes of the perspective grid of FIG. 45, where each cell in these matrices represents one node in the xy-planes. FIG. 49 illustrates 14 matrices representing the 14 potential yz-planes of the perspective grid of FIG. 46, where each cell in these matrices represents one node in the yz-planes. FIG. 50 illustrates 6 matrices representing the 6 potential xz-planes of FIG. 47, where each cell in these matrices represents one node in the xz-planes.

Each cell of the planar matrices indicates “0” or “1”, where the “0” numeral indicates an empty cell, and the “1” numeral indicates the existence of a node. When the user draws a plane in the perspective grid on the computer display, the correspondent matrix of this plane changes the “0” cells into “1” cells to represent the drawn plane.

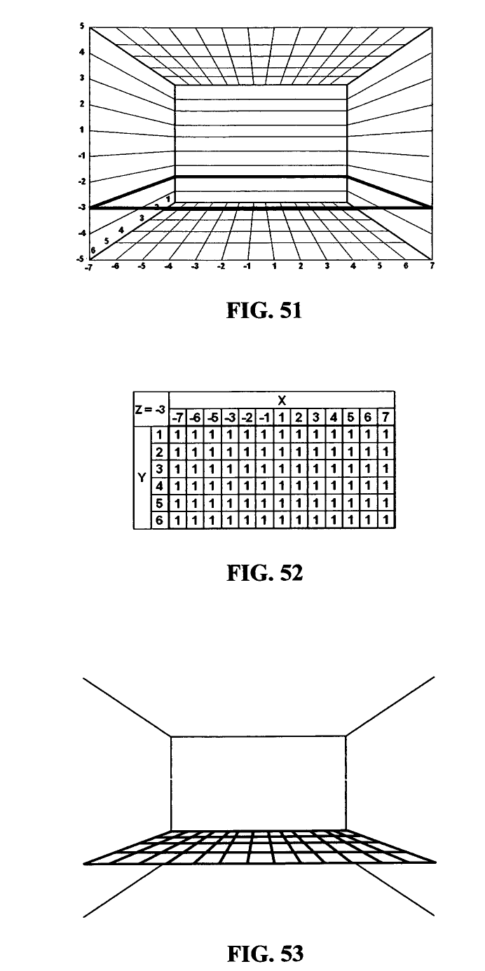

In other words, when the user provides a graphical input to the computer system by creating, moving, or editing a plane, the computer system translates this graphical input into a numerical model using the planar matrices. For example, if the user created an xy-plane as illustrated in FIG. 51, the correspondent matrix that represents this xy-plane will be transferred into the matrix of FIG. 52, where the computer system fills each cell of this matrix with the numeral “1” while the cells of all other matrices remain empty, or include the numeral “0”.

In this case, when the user clicks on the xy-corner plane of the corner icon that leads to the creation of the xy-plane of FIG. 51, as described previously, the computer system receives this input and translates it into the matrix of FIG. 52 to fill each of cell with the numeral “1”. After that the computer system translates the “1” numerals of this matrix's cells into a graphical presentation on the perspective grid drawing a correspondent xy-plane on the computer display as illustrated in FIG. 53.

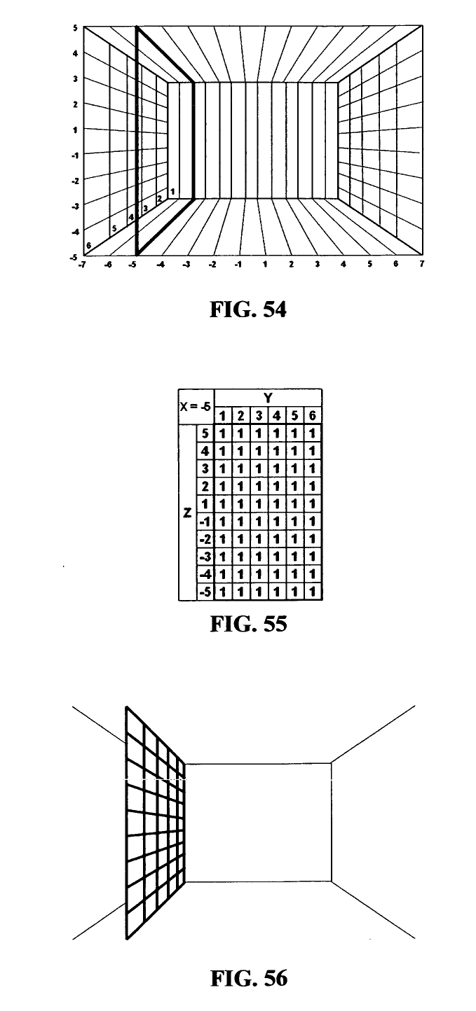

Also, if the user created a yz-plane as illustrated in FIG. 54, the correspondent matrix that represents this yz-plane will be transformed into the matrix of FIG. 55, where the computer system filled each of the cells of this matrix with the numeral “1” while the cells of all other matrices, except the matrix of FIG. 52, remain empty or include the numeral “0”.

Again, in this case, when the user clicks on the yz-corner plane of the corner icon that leads to the creation of the yz-plane of FIG. 54, as described previously, the computer system receives this input and translates it into the matrix of FIG. 55 to fill each of its cells with the numeral “1”. After that, the computer system translates the “1” numerals of this matrix's cells into a graphical presentation on the perspective grid drawing a correspondent yz-plane on the computer display as illustrated in FIG. 56.

In FIGS. 53 and 56 the computer system present each trapezoid by drawing its four corners or nodes on the computer display then filling this trapezoid with a transparent or opaque color according to the user's choice. However, in the previous two figures the trapezoids are filled with an opaque, white color.

In cases where the user successively creates two planes, such as the xy-plane of FIG. 53 and the yz-plane of FIG. 56 in the perspective grid, the order of drawing the trapezoids of these two planes on the computer display is vital to make the two planes look like they are intersected with each other in three dimensions.

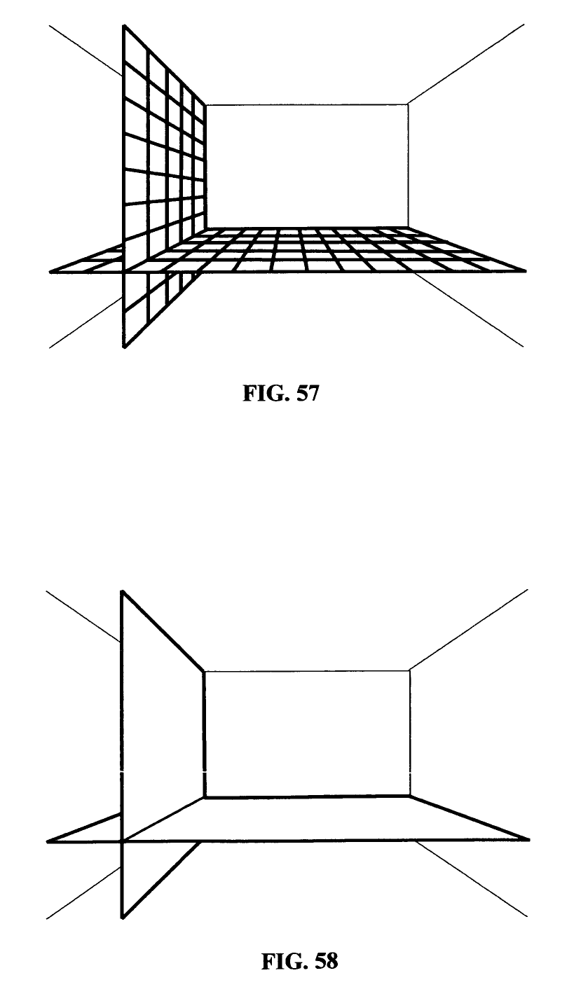

FIG. 57 illustrates the two planes drawn in the perspective grid on the computer display where they look like they are intersected in three dimensions with each other. As shown in this figure, some trapezoids of the two planes are drawn on top of each other on the computer display to give the look of the three dimensional intersection of the two planes. FIG. 58 illustrates the two intersected planes of FIG. 57 presenting on the computer display without displaying the lines of the trapezoids.

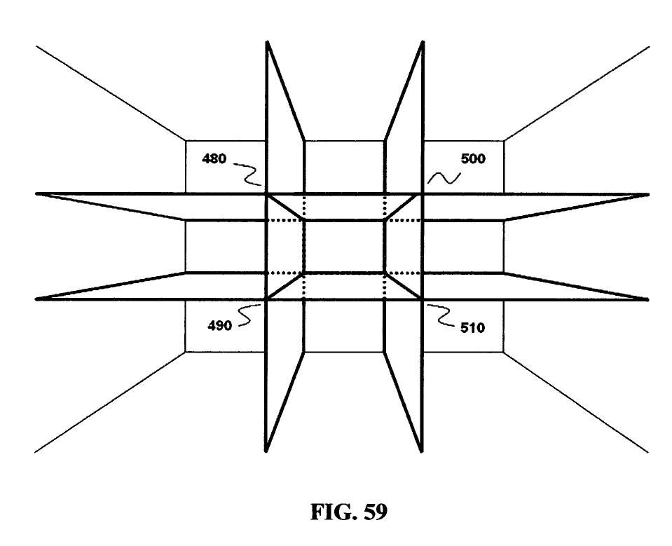

The correct order of succession of the drawn trapezoids or rectangles in the perspective grid on the computer display is important to make the intersection look like a three dimensional intersection. FIG. 59 illustrates four potential intersections 480 to 510 between an xy-plane and a yz-plane, where each one of these four intersections forms a cross-shape, where each cross-shape has four sections or parts which are a “top”, “bottom”, “left”, and “right” section. The “left” and “right” sections are two parts of the xy-plane, and the “top” and “bottom” sections are two parts of the yz-plane.

The first type of intersection 480 occurs on the left side above the vanishing point where the values of the x-axis are negative and the values of the z-axis are positive. In this type of intersection, the successive order of drawing the trapezoids on the computer display is the “top”, then the “left”, then the “bottom”, and concludes with the “right” section of the cross-shape.

The second type of intersection 490 occurs on the left side below the vanishing point where the x-axis and the z-axis values are negative. In this type of intersection, the successive order of drawing the trapezoids on the computer display is the “left”, then the “bottom”, then the “right”, and concludes with the “top” section of the cross-shape.

The third type of intersection 500 occurs on the right side above the vanishing point where the x-axis and the z-axis values are positive. In this type of intersection, the successive order of drawing the trapezoids on the computer display is the “top”, then the “right”, then the “bottom”, and concludes with the “left” section of the cross-shape.

The fourth type of intersection 510 occurs on the right side below the vanishing point where the x-axis values are positive and the z-axis values are negative. In this type of intersection, the successive order of drawing the trapezoids on the computer display is the “right”, then the “bottom”, then the “left”, and concludes with the “top” section of the cross-shape.

The xz-planes are not stated in the previous four types of intersection since they are drawn on the computer display before drawing the four sections of the cross-shape. In other words, the computer system draws an xz-plane then draws the intersection between the xy-plane and the yz-plane that occurs between the drawn xz-plane and its successive xz-plane, and so on until reaching the last xz-plane in the perspective grid on the computer display.

As illustrated in the previous figures, the type of intersection depends on the position of the intersection relative to the position of the vanishing point, where in this example the position of the vanishing point represents the position of the point-of-view. However, if the positions of the vanishing point and the point-of-view are different, then the type of intersection depends on the position of the point-of-view.

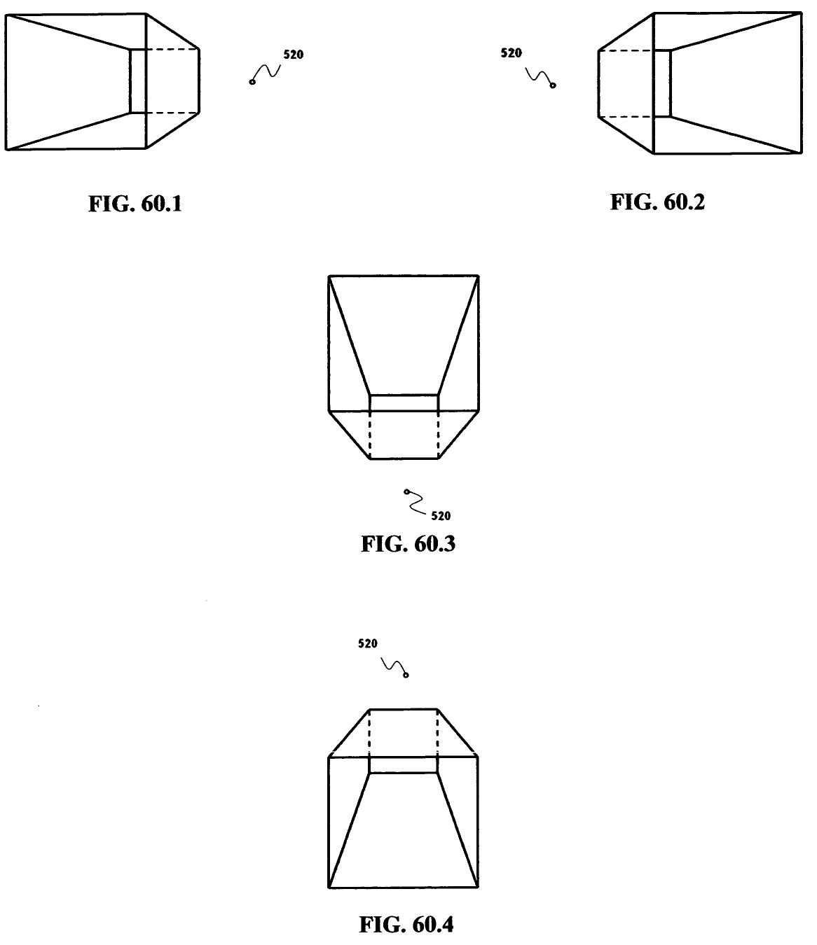

FIG. 60.1 illustrates moving the vanishing point of the interior space of FIG. 44 on the positive x-axis of the computer display; FIG. 60.2 illustrates moving the vanishing point on the negative x-axis of the computer display; FIG. 60.3 illustrates moving the vanishing point on the negative y-axis of the computer display; FIG. 60.4 illustrates moving the vanishing point on the positive y-axis of the computer display.

In the previous four figures, the vanishing point that represents the point-of-view changes its position; accordingly, the same intersection may change its type from one figure to another. For example, the second type of intersection 490 in FIG. 60.1 will be changed into the fourth type of intersection 510 in FIG. 60.2. Also, the third type of intersection 500 in FIG. 60.3 will be changed into the fourth type of intersection 510 in FIG. 60.4.

The previously described four types of intersection are valid for the two-point perspective and the three-point perspective. In other words, the process of the present invention is valid for all types of perspectives. The only difference is the shape of the perspective grids that depends on the number and the positions of the vanishing points.

In addition to the possibility of moving the point-of-view along the x-axis and the y-axis on the computer display, the user can rotate the 3D GUI horizontally and/or vertically, or walk thought its planes and objects in 3D on the computer display. In such cases, with each successive movement, the computer system adopts the new position of the point-of-view and changes the types of intersections between the intersected planes. This provides an ability to view the details of the 3D GUI according to the position or the movement of the point-of-view on the computer display.

The main advantage of moving or walking though the present 3D GUI is that this type of movement looks like a 3D movement on the computer display, although the present 3D GUI is in actuality a 2D drawing; this 2D drawing changes its shape on the computer display according to the movement of the point-of-view. This advantage makes the file size of the present invention extremely light in comparison to the files of traditional three dimensional applications.

As described previously, each node is identified in the planar matrices with the x, y, and z components of the perspective grid. However, to locate the position of a node on the computer display using the x, y, and z components of the perspective grid, the computer system considers the position of the vanishing point/s on the computer display.

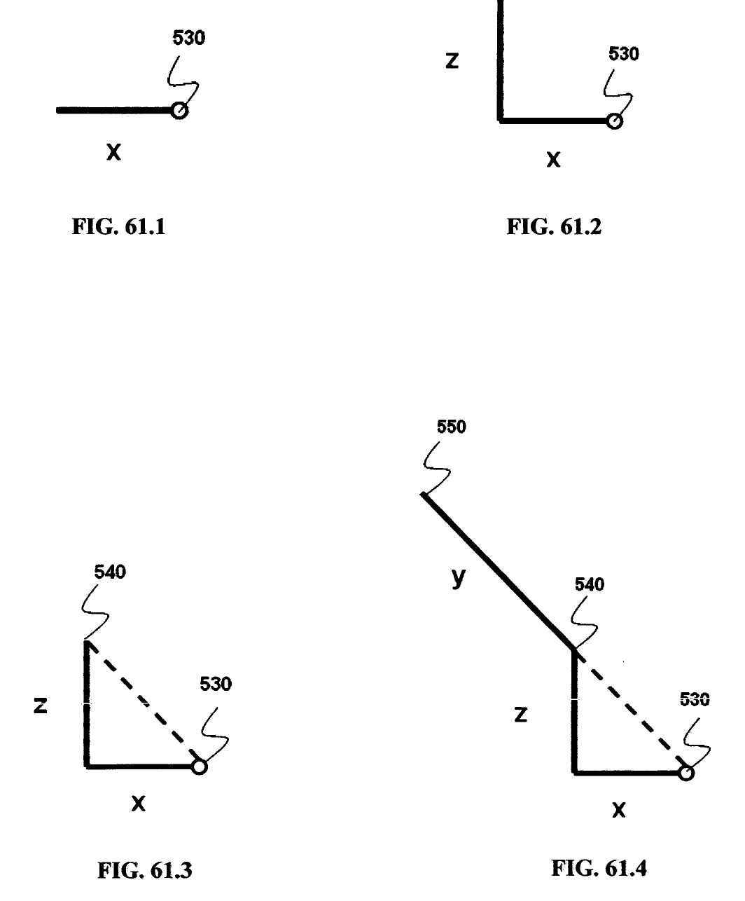

FIGS. 61.1 to 61.4 illustrate four steps to locate a position of a node in a perspective grid of a one-point perspective on the computer display using the x, y, and z components of the planar matrices.

FIG. 61.1 illustrates the first step when moving a horizontal distance “x” from a vanishing point 530; FIG. 61.2 illustrates the second step when moving a vertical distance “z” from the vanishing point; FIG. 61.3 illustrates the third step that defines the sloped line that connects between the vanishing point and point 540 which is the resultant of the x and y distances. FIG. 61.4 illustrates the fourth step when moving a distance “y” on the extension of the sloped line to reach the position 550 of the node on the computer display. The x, y, and z distances are, respectively, equal to the x, y, and z components of the node in the planes matrices.

Generally, in the one-point perspective the two components x and z of the nodes represent, respectively, the horizontal and vertical directions of the computer display; however, this is not the case with the two-point perspective and the three points perspective.

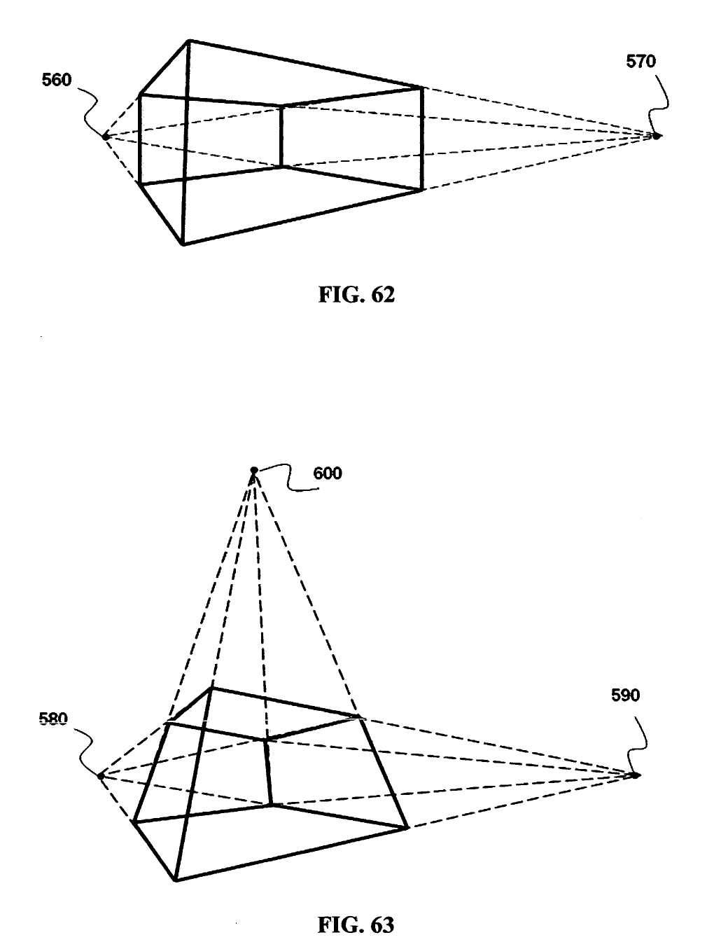

For example, FIG. 62 illustrates a two-point perspective with two vanishing points 560 and 570 presented on a computer display. In this case, to locate a position of a node on the computer display, the x component of the node represents the direction of the line that connects between the first vanishing point 560 and the second vanishing point 570 on the computer display.

FIG. 63 illustrates a three-point perspective with three vanishing points 580, 590, and 600 presented on a computer display. In this case, to locate the position of a node on the computer display, the x component of the node represents the direction of a line that connects between the first vanishing point 580 and the second vanishing point 590. The z component of the node represents the direction of a line that connects between the end of the previous x distance (that represents the x component) and the third vanishing point 600.

Using the four steps described in FIGS. 61.1 to 61.4 for the one-point perspective is also valid for use with the two-point perspective and the three-point perspective with only a changing of direction in locating the x and y components on the computer display as previously described.

The method of the present invention is also valid for isometric drawings, where, as known in the art, said isometric drawings have no vanishing points, or in other words, the parallel lines or their extensions do not intersect or meet at any point.

Generally, it is important to note that the created planes on the computer display can take other forms or styles than the planes that are parallel to the xy, xz, and yz-planes. For example, the created planes can be vertical strips and horizontal strips of a cylinder or a sphere, where in this case, the matrices will be formed to represent or model said vertical and horizontal strips

Finally, it is important to note that if the present invention of the 3D windows system becomes commercially available, it is believed that software developers would come up with innumerable additional uses and applications to serve a large number of the computer users.

1. A 3D windows system that enables the user to interact with a graphics user interface in three dimensions on the computer display, wherein said 3D windows system comprises the steps of:
a) presenting an initial graphics user interface on the computer display, whereas said initial graphics user interface is comprised of a plurality of original planes drawn on a perspective grid.
b) enabling the user to provide a graphical input to the computer system representing creating new planes on said perspective grid, or moving, dividing, deleting, copying, pasting, or rotating said new planes on said perspective grid.
c) dividing said plurality of original planes and said new planes into a number of hidden units whereas each one of said hidden units is a polygon or a surface that has four corners which means nodes.
d) forming a plurality of matrices whereas each matrix of said plurality of matrices represents one plane of said original planes or one plane of said new planes, where each cell of said plurality of matrices represents one node of said nodes.
e) converting said graphical input into a plurality of numerals whereas each numeral of said plurality of numerals fills one cell of said plurality of matrices to represent an existing of a node of said nodes.
f) transforming said plurality of numerals into polygons to be drawn on said perspective grid in a successive order representing viewing said polygons in three dimensions from the point-of-view of said perspective grid.

2. A method that enables the user to create planes in a three-dimensional virtual environment on the computer display wherein said method comprises the steps of:
a) moving the computer cursor to a point of a line of said three-dimensional virtual environment to display a small circle 150 at the intersection between the computer cursor and said line on the computer display.
b) clicking on said small circle to provide an input to the computer system representing the user's need to create a plane in three dimensions starting from the position of said small circle on the computer display.
c) presenting an icon corner comprised of an x-corner line 160 representing the x-axis of said three-dimensional virtual environment, a y-corner line 170 representing the y-axis of said three-dimensional virtual environment, and a z-corner line 180 representing the z-axis of said three-dimensional virtual environment on the computer display.
d) presenting an xy-corner plane 190 that appears between said x-corner line and said y-corner line parallel to the xy-plane when the computer cursor is moved between said x-corner line and said y-corner line, presenting an xz-corner plane 200 that appears between said x-corner line and said z-corner line parallel to the xz-plane when the computer cursor is moved between said x-corner line and said z-corner line, and presenting a yz-corner plane that appears between said y-corner line and said z-corner line parallel to the yz-plane when the computer cursor is moved between said y-corner line and said z-corner line on the computer display.
e) creating an xy-plane when clicking on said xy-corner plane, creating an xz-plane when clicking on said xz-corner plane, and creating a yz-plane when clicking on said yz-corner plane on the computer display

3. A method that enables the computer system to present an intersection between a first plane and a second plane relative to a point-of-view on the computer display, wherein said intersection forms a cross-shape or the like, that is comprised of: a “top” section, a “bottom” section, a “left” section, and a “right” section, and said method comprises the steps of:
a) classifying said intersection into; a first type 480 that occurs when said intersection is located on the left side above said point-of-view, a second type 490 that occurs when said intersection is located on the left side below said point-of-view, a third type 500 that occurs when said intersection is located on the right side above said point-of-view, and a fourth 510 type that occurs when said intersection is located on the right side below said point-of-view.
b) successively drawing said “top” section, said “left” section, said “bottom” section, and said “right” section when said intersection is classified as said first type, successively drawing said “left” section, said “bottom” section, said “right” section, and said “top” section when said intersection is classified as said second type, successively drawing said “top” section, said “right” section, said “bottom” section, and said “left” section when said intersection is classified as said third type, and successively drawing said “right” section, said “bottom” section, said “left” section, and said “top” section when said intersection is classified as said fourth type.

4. The 3D windows system of claim 1 wherein said perspective grid is a one-point perspective that has one vanishing point.

5. The 3D windows system of claim 1 wherein said perspective grid is a two-point perspective that has two vanishing points.

6. The 3D windows system of claim 1 wherein said perspective grid is a three-point perspective that has three vanishing points.

7. The 3D windows system of claim 1 wherein said perspective grid is an isometric drawing that has no vanishing points.

8. The 3D windows system of claim 1 wherein said graphics user interface is comprised of a plurality of planes that is parallel to the xy, xz, and yz-planes.

9. The 3D windows system of claim 1 wherein said graphics user interface is comprised of a plurality of planes that is parallel to vertical strips and horizontal strips of a cylinder.

10. The 3D windows system of claim 1 wherein said graphics user interface is comprised of a plurality of planes that is parallel to vertical strips and horizontal strips of a sphere.

11. The 3D windows system of claim 1 wherein said graphics user interface is utilized to function as a three-dimensional desktop on the computer display.

12. The 3D windows system of claim 1 wherein said graphics user interface is utilized to display icons, menus, images, text, or the like of a desktop application on the computer display.

13. The 3D windows system of claim 1 wherein said graphics user interface is utilized to display icons, menus, images, text, or the like of a web-based application on the computer display.

14. The 3D windows system of claim 1 wherein the position of said point-of-view can be changed on the computer display.

15. The method of claim 2 wherein said planes form a three dimensional graphics user interface on the computer display.

16. The method of claim 2 wherein said planes form a three dimensional virtual object such as an icon, menu, display window, or the like on the computer display.

17. The method of claim 3 wherein said first plane and said second plane are parallel to two planes of the xy-plane, xz-plane, and yz-plane.

18. The method of claim 3 wherein said first plane and said second plane are vertical strips and horizontal strips of a cylinder.

19. The method of claim 3 wherein said first plane and said second plane are vertical strips and horizontal strips of a sphere.
